(19) United States
(12) Patent Application Publication
(10) Pub. No.: US 2021/0319414 A1
(43) Pub. Date: Oct. 14, 2021

(54) VEHICLE AND NOTIFICATION MANAGEMENT IN A WIRELESS NETWORK

(71) Applicant: Charter Communications Operating, LLC, St. Louis, MO (US)

(72) Inventor: Saran Khalid, Denver, CO (US)

(21) Appl. No.: 16/847,961

(22) Filed: Apr. 14, 2020

(51) Int. Cl. G06Q 20/10; G08G 1/07; H04W 4/44; G08G 1/01; G07B 15/06; G07B 15/04; G06Q 30/04; G05B 15/02; G01C 21/28; G01C 21/34; G05D 1/02; B60W 30/095; B60W 50/14

(52) U.S. Cl. CPC G06Q 20/102; B60W 2556/45; H04W 4/44; G08G 1/0145; G07B 15/063; G07B 15/04; G06Q 30/04; G05B 15/02; G01C 21/28; G01C 21/3461; G05D 1/0285; B60W 30/0956; B60W 50/14; G06Q 2240/00; G05D 2201/0213; B60W 2554/4029; G08G 1/07

(57) ABSTRACT

A system includes a wireless monitor station. The wireless station monitors a region in which one or more vehicles frequent such as automobiles, trains, etc. The wireless station receives a wireless communication indicating presence of a first vehicle in the monitored region. The first communication includes a unique identifier value assigned to the first vehicle. Based on detected presence of the first vehicle in the monitored region, the wireless station controls traffic flow associated with the monitored region.

### BACKGROUND

Conventional wireless networks typically include one or more cells of wireless coverage, each supported by a wireless base station for providing wireless services. By arranging the wireless base stations at regularly spaced intervals, a coverage region of each base station is adjacent a coverage region of another base station, therefore providing a continuous coverage area from the aggregation of coverage areas emanating from each base station.

### BRIEF DESCRIPTION OF EMBODIMENTS

Embodiments herein include novel ways of managing vehicular traffic in a network environment.

For example, one embodiment herein includes one or more wireless monitor stations such as a first wireless monitor station, a second wireless monitor station, etc. The first wireless station monitors a first region in which one or more vehicles frequent such as automobiles, trains, etc. During monitoring, assume that the first wireless station receives a wireless communication indicating presence of a first vehicle in the first monitored region. The first communication includes a unique identifier value assigned to the first vehicle. Based on detected presence of the first vehicle in the monitored region as indicated by the first communication and the first unique identifier value, the wireless station controls traffic flow associated with the monitored region.

Note that the system as described herein implements any suitable communication to transmit and receive wireless data. For example, in one embodiment, each of multiple wireless communications between the first wireless monitor station and the first vehicle are encoded in accordance with a V2I (Vehicle-to-Infrastructure) communication protocol.

In accordance with further example embodiments, to learn of any vehicles, the first wireless monitor station communicates a respective probe request in the monitored region to any present vehicle. In response to communicating the probe request, the first monitor station in the monitored region receives a response from any of one or more entities (such as vehicles, persons, etc.) present in the monitored region.

Each of the entities (such as vehicles) in the monitored region includes a respective wireless station (communication device) that receives a respective probe request from the first wireless monitor station. Each of the respective wireless stations (associated with vehicles) responds to the respective probe request. After establishing a respective wireless communication link with the first wireless station, each respective wireless station communicates any suitable information (such as location information, identity information, etc.) to the wireless monitor station such as its assigned unique identity value. In this manner, the first wireless station is able to track locations of the respective entities as well as receive information about each of the respective entities.

In accordance with further embodiments, one or more of the remote wireless stations is affixed to a respective vehicle being monitored.

Yet further embodiments herein include controlling traffic flow such as via control of a movement of a physical barrier, allowing the first vehicle and potentially other vehicles to pass. In certain instances, the first wireless monitor station is connected to a vehicle management system that detects presence of one or more vehicles in a restricted area such as a parking lot.

In one embodiment, the system as described herein includes a second wireless station that monitors a second region. In such an instance, the second wireless station communicates a second probe request to detect vehicular presence in the second monitored region. In further example embodiments, the second wireless monitor station is disposed at a disparate location with respect to the first wireless monitor station. The second wireless station receives the wireless response indicating presence of the first vehicle in the second region. In a similar manner as previously discussed, the second wireless response from the first vehicle to the second wireless monitor station includes the unique identifier value assigned to the vehicle. The second wireless station controls movement of the first vehicle from the second region based at least in part on the second wireless response.

In accordance with further example embodiments, the second wireless station monitors presence of the first vehicle in a second restricted area and calculates fees due from a user based on monitored presence of the first vehicle in multiple areas such as a the first area (such as a first parking lot) and a second area (such as a second parking lot).

Still further embodiments herein include, prior to controlling movement of the first vehicle, providing notification of a fee due to a user of the vehicle based on a second wireless communication from the first wireless station to the user. In response to detecting payment of the fee due, the corresponding wireless station notifies a user of the vehicle to pass through the first monitored region.

In accordance with further example embodiments, the monitor system as described herein receives registration of each vehicle such as via input from a mobile communication device operated by a user of a respective vehicle. In such an instance, the monitor system is aware of each vehicle and corresponding unique identifier value. The wireless monitor station controls movement of the first vehicle from the first region based at least in part on the received identity of the vehicle as learned during registration. For example, in one embodiment, based on detecting that the vehicle was previously registered, the wireless station notifies the user of the vehicle to pass through the monitored region such as to a parking lot. Additionally, the wireless station notifies the vehicle to exit a parking lot. In either case, the wireless station can be configured to control a physical barrier enabling the vehicle to enter the parking lot or exit parking lot.

In accordance with yet further example embodiments, the registration of the vehicle with the monitoring system includes the mobile communication device providing the monitor system the unique identifier value assigned to the first vehicle. Based on the received registration information, the monitor system maps the unique identifier value, the vehicle, user, and to the mobile communication device to each other.

Still further example embodiments herein include receiving the first wireless communication from the vehicle at the first wireless station in response to communicating a probe request from the first wireless monitor station. In one embodiment, the probe request is transmitted in a window of time in which the first vehicle (such as a train or other entity) is scheduled to be present in the monitored region. If no vehicle is detected as being present after transmission of a first probe request in the monitored region, the wireless station transmits a second probe request in the monitored region. If no vehicle detected as being present after transmission of the second probe request, the wireless station transmits a third probe requests in the monitored region. In this manner, the wireless station repeatedly attempts to detect presence of the vehicle in the monitored region.

As previously discussed, the wireless station repeatedly transmits probe requests in the monitored region to learn of presence of a respective vehicle, regardless of whether the vehicle is expected to be present or not. If a respective vehicle is expected to be present at the scheduled time, the wireless station can be configured to increase a rate at which probe requests are transmitted in the monitored region in a scheduled window of time to ensure that the vehicle is detected as being present as early as possible.

Yet further embodiments herein include verifying an identity of the first vehicle based on the received unique identifier value. In one embodiment, subsequent to verification of the vehicle via the respective unique identifier value, the wireless station controls a respective physical barrier to allow passage of the vehicle into an otherwise restricted area.

In yet further example embodiments, the vehicle includes multiple communication devices that are potentially in communication with the wireless station. For example, the vehicle may be a train including multiple train cars. A first communication device assigned a first unique identifier value is affixed to a leading end of the vehicle. A second communication device assigned a second unique identifier value is affixed to a trailing end and of the vehicle. In one embodiment, the wireless station receives a first wireless communication from the first communication device (wireless station) disposed at the leading end of the vehicle passing through the monitored region. The wireless station receives a second wireless communication from the second communication device disposed at the trailing end of the first vehicle passing through the monitored region.

In still further example embodiments, the first vehicle as described herein travels on a first vehicle pathway through the monitored region. The wireless station is operative to control a physical barrier (or other control mechanism such as a traffic light, horn, etc.) at an intersection of a second vehicle pathway crossing the first vehicle pathway. The physical barrier controls movement of a second vehicle along the second vehicle pathway across the first pathway based on the detected presence of the first vehicle in the monitored region.

In one embodiment, the wireless station also controls movement of the respective vehicle. For example, in one embodiment, the wireless station communicates a signal to the first vehicle granting permission to the first vehicle to pass through the intersection.

Note further that the wireless monitor station can be configured to receive any type of information from the vehicle. For example, in one embodiment, the wireless station receives a wireless communication from the vehicle indicating information such as a its current geographical location, speed, etc.

Note further that the wireless monitor station can be configured to monitor presence of any type of entity in the monitored region. For example, in one embodiment, the wireless monitor station detects presence of one or more pedestrians in the monitored region as well as the vehicle. In such an instance, the wireless station notifies an operator of the vehicle of the presence of the one or more pedestrians in the monitored region. In one embodiment, the wireless station detects that a first pedestrian is located in a corresponding path of the vehicle and that the first pedestrian is in danger of being hit or run over by the vehicle. In this case, the notification to the vehicle ensures that the operator of the vehicle is aware of the pedestrian.

Conversely, note that the wireless station can be configured to provide notification of the detected presence of the vehicle in the monitored region to a communication device operated by a user disposed in a pathway of the first vehicle. In such an instance, the user is notified of potential danger of the corresponding vehicle. If the wireless station detects that the user (such as a pedestrian) is still present in a pathway of the corresponding vehicle after providing notification of same, the wireless station can be configured to control operation of the first vehicle such that the user is not injured by the vehicle.

These and other embodiments of further discussed herein.

Note that any of the resources as discussed herein can include one or more computerized devices, wireless access points, wireless base stations, mobile communication devices, servers, base stations, wireless communication equipment, communication management systems, workstations, user equipment, handheld or laptop computers, or the like to carry out and/or support any or all of the method operations disclosed herein. In other words, one or more computerized devices or processors can be programmed and/or configured to operate as explained herein to carry out the different embodiments as described herein.

Yet other embodiments herein include software programs to perform the steps and operations summarized above and disclosed in detail below. One such embodiment comprises a computer program product including a non-transitory computer-readable storage medium (i.e., any computer readable hardware storage medium) on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage medium such as an optical medium (e.g., CD-ROM), floppy disk, hard disk, memory stick, memory device, etc., or other a medium such as firmware in one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, embodiments herein are directed to a method, system, computer program product, etc., that supports operations as discussed herein.

One embodiment includes a computer readable storage medium and/or system having instructions stored thereon. The instructions, when executed by computer processor hardware, cause the computer processor hardware (such as one or more co-located or disparately processor devices) to: monitoring a region; receiving a first wireless communication indicating presence of a first vehicle in the monitored region, the first communication including a unique identifier value assigned to the first vehicle; and controlling traffic flow associated with the monitored region based on detected presence of the first vehicle in the monitored region.

The ordering of the steps above has been added for clarity sake. Note that any of the processing steps as discussed herein can be performed in any suitable order.

Other embodiments of the present disclosure include software programs and/or respective hardware to perform any of the method embodiment steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of supporting different wireless services. However, it should be noted that embodiments herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of embodiments herein (BRIEF DESCRIPTION OF EMBODIMENTS) purposefully does not specify every embodiment and/or incrementally novel aspect of the present disclosure or claimed invention(s). Instead, this brief description only presents general embodiments and corresponding points of novelty over conventional techniques. For additional details and/or possible perspectives (permutations) of the invention(s), the reader is directed to the Detailed Description section (which is a summary of embodiments) and corresponding figures of the present disclosure as further discussed below.

### BRIEF DESCRIPTION OF THE DRAWINGS

FIG. 1 is an example diagram illustrating a wireless network environment and management of vehicles according to embodiments herein.

FIG. 2 is a more particular example diagram illustrating a wireless network environment and management of vehicles according to embodiments herein.

FIG. 3 is an example diagram illustrating a wireless communication protocol supporting communications between a wireless monitor station and a vehicle according to embodiments herein.

FIG. 4 is an example diagram illustrating management and tracking of a vehicle in a first area according to embodiments herein.

FIG. 5 is an example diagram illustrating management and tracking of a vehicle in a second area according to embodiments herein.

FIG. 6 is an example diagram illustrating map information tracking vehicles and use of a respective resource such as a parking lot according to embodiments herein.

FIG. 7 is an example diagram illustrating a wireless network environment and vehicle management according to embodiments herein.

FIG. 8 is an example diagram illustrating control of traffic at an intersection according to embodiments herein.

FIG. 9 is an example diagram illustrating detection of an inbound and outbound vehicle according to embodiments herein.

FIG. 10 is an example diagram illustrating a wireless system and corresponding management of vehicles according to embodiments herein.

FIG. 11 is an example diagram illustrating a wireless communication protocol supporting communications between a wireless monitor station and a vehicle according to embodiments herein.

FIG. 12 is an example diagram illustrating a wireless communication protocol supporting communications between a wireless monitor station and a pedestrian according to embodiments herein.

FIG. 13 is an example diagram illustrating monitoring of pedestrians and providing notifications according to embodiments herein.

FIG. 14 is an example diagram illustrating a computer architecture in which to execute one or more embodiments as discussed herein.

FIG. 15 is an example diagram illustrating a method according to embodiments herein.

The foregoing and other objects, features, and advantages of the invention will be apparent from the following more particular description of preferred embodiments herein, as illustrated in the accompanying drawings in which like reference characters refer to the same parts throughout the different views. The drawings are not necessarily to scale, with emphasis instead being placed upon illustrating the embodiments, principles, concepts, etc.

### DETAILED DESCRIPTION

In accordance with general embodiments, a wireless network environment includes one or more wireless monitor stations. Each of the wireless station monitors a region in which one or more vehicles frequent such as automobiles, trains, etc. During monitoring, the wireless station receives a wireless communication indicating presence of a first vehicle in the monitored region. The first communication includes a unique identifier value assigned to the first vehicle. Based on detected presence of the first vehicle in the monitored region, and identity, the wireless station controls traffic flow associated with the monitored region.

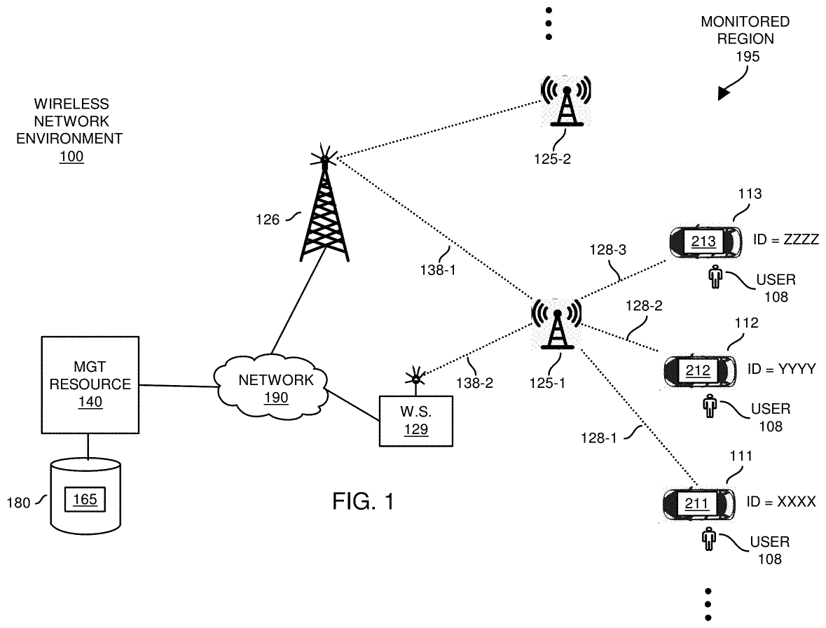

FIG. 1 is an example diagram illustrating a wireless network environment and management of vehicles according to embodiments herein.

As shown, the wireless network environment 100 includes one or more vehicles 111, 112, 113, etc., in communication (simultaneously or at different times) with wireless station 125-1. Note that the wireless network environment 100 includes any number of vehicles in communication with respective wireless stations 125 (such as wireless station 125-1, wireless station 125-2, etc.).

Additionally, each respective vehicle includes a corresponding wireless station to communicate with the wireless station 125 (such as a road-side unit or RSU). For example, vehicle 111 includes wireless station 211; vehicle 112 includes wireless station 212; vehicle 113 includes wireless station 213; and so on.

In one nonlimiting example embodiment, each of the respective wireless stations is affixed to the corresponding vehicle. For example, in one embodiment, the wireless station 211 is affixed to vehicle 111; wireless station 212 is affixed to the vehicle 112; wireless station 213 is affixed to the vehicle 113; and so on.

Alternatively, note that any of the wireless stations 211, 212, 213, etc., can be handheld devices operated by a respective user operating a corresponding vehicle.

In yet further example embodiments, the wireless stations 211, 212, 213, etc., are affixed to the vehicles and each of the drivers of the vehicles operates a respective mobile communication device.

As further shown, wireless communication link 128-1 supports wireless communications between the wireless station 125-1 and the wireless station 211; wireless communication link 128-2 supports wireless communications between the wireless station 125-1 and the wireless station 212; wireless communication link 128-3 supports wireless communications between the wireless station 125-1 and the wireless station 213; and so on.

In a similar manner, each of the wireless stations 211, 212, 213, etc., can be in communication wireless station 125-2.

As further shown, each of the wireless stations 125 is in communication with the management resource 140 via any of multiple different types of communication links. For example, in one embodiment, the wireless station 125-1 establishes a wireless communication link 138-1 between the wireless station 125-1 and the wireless station 126 (such as via LTE, 5G, etc.). Additionally or alternatively, the wireless station 125-1 establishes a respective wireless communication link 138-2 with the wireless station 129. Network 190 provides connectivity of the respective wireless station 126 and wireless station 129 to the management resource 140. In one embodiment, as its name suggests, the management resource 140 manages one or more functions associated with vehicles 111, 112, 113, etc.

In yet further example embodiments, each wireless station on a respective vehicle communicates with the wireless station 125 (such as road-side unit or RSU) at the entry into a corresponding area or geographical region. In one embodiment, the geographical region is a parking garage or parking lot. In such an instance, the wireless station 125-1 resides at the entry of the garage/restricted area. Thus, in one embodiment, the wireless station 125-1 communicates with any detected vehicle attempting to enter the parking garage to determine if a respective physical barrier such as a gate should be opened.

The wireless station 125-2 resides at the exit of the garage/restricted area. In one embodiment, as further discussed herein, the wireless station 125-2 communicates with any detected vehicle attempting to exit the parking garage to determine if a respective physical barrier such as a gate should be opened.

Note that the wireless communication links 128 can support any type of wireless communications. For example, in one embodiment, the wireless communication links 128 (128-1, 128-2, 128-3, etc.) support wireless connectivity with the wireless station 125 in accordance with a V2I (Vehicle to Infrastructure) wireless communication protocol. Additionally, or alternatively, the wireless communication links support LTE, WiFi™, or any suitable type of communication.

Via respective wireless communications between the wireless stations 211, 212, 213, etc., and the management resource 140, the management resource 140 performs one or more functions associated with the vehicles 111, 112, 113, etc. For example, the management resource 140: i) tracks information such as presence or location of the respective vehicles in the monitored region 195, ii) tracks the duration in which the vehicles are present in the monitored region, iii) control traffic flow of one or more vehicles in the monitored region 195, etc.

Accordingly, embodiments herein include one or more wireless monitor stations such as a first wireless monitor station, 125-1 a second wireless monitor station 125-2, etc. The first wireless station 125-1 monitors a first region in which one or more vehicles frequent such as automobiles, trains, etc. During operation, assume that the first wireless station 125-1 receives a wireless communication indicating presence of a first vehicle 211 in the first monitored region. The first communication includes a unique identifier value (such as unique identifier value of XXXX) assigned to the first vehicle 211. Based on detected presence of the first vehicle 211 in the monitored region as indicated by the first communication and the first unique identifier value XXXX, and control input from the management resource 140 or other suitable entity, the wireless station 125-1 controls traffic flow (of one or more vehicles 211, 212, etc.) associated with the monitored region 195 (or different sub-regions).

As further discussed herein, traffic flow control can include communicating control information to the respective vehicle, controlling (such as opening and closing) a physical barrier such as a gate, controlling a traffic light, etc.

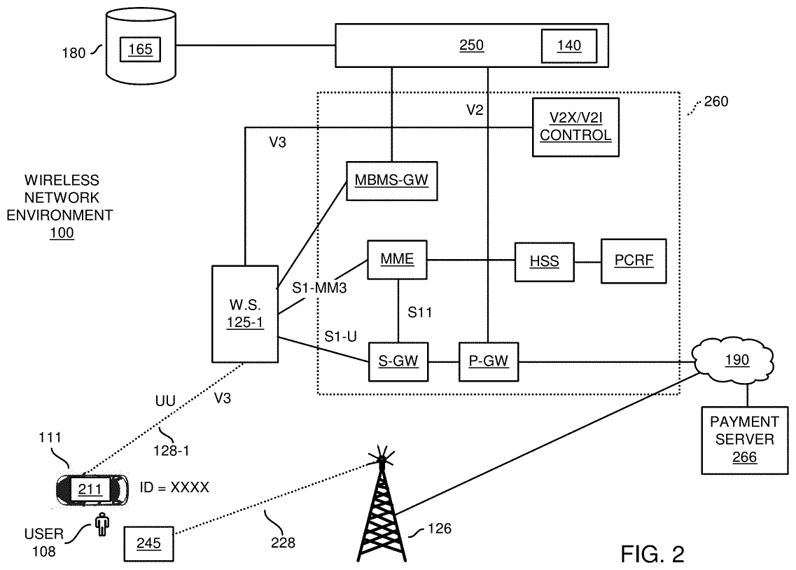

FIG. 2 is an example diagram illustrating a wireless network environment and management of vehicles according to embodiments herein.

In this example embodiment, the wireless network environment 100 includes wireless network core 260 including MBMS-GW, MME, S-GW, P-GW, HSS, V2X/V2I Controller, PCRF, etc.

The core network 260 (and corresponding management components MBMS-GW, MME, S-GW, P-GW, HSS, V2X/V2I Controller, PCRF, etc.) provides connectivity between the respective wireless stations 211, 212, 212, etc., and the management resource 140 (traffic management resource).

In this example embodiment, the wireless communication link 128-1 supports communications via one or more wireless communication protocols over one or more corresponding wireless communication bands to the wireless station 125-1.

Communication device 245 operated by the user 108 is in communication with the management resource 140 over wireless communication link 228 through network 190.

Note that, in one embodiment, the management resource 140 (such as hardware and/or executed software) is a V2I application executed on application server 250.

In a similar manner as previously discussed, management resource 140 has access to repository 180 (such as in the cloud or other suitable location), which stores status information 165 (a.k.a., management information, mapping information, etc.). In one embodiment, the status information 165 stores any suitable information such as vehicle information including VIN number, license plate numbers, assigned unique identifier values, etc.

As further discussed herein, the status information 165 (such as derived at least in part on the user 108 registering with the management resource 140 through wireless station 126 and network 190) can be configured to store timing information such as what days, time, and expiration date of the vehicle entering a respective authorized area such as a parking lot, parking garage, etc.

In certain instances, the management resource 140 prevents entry of vehicles into restricted areas if they are not authorized to enter.

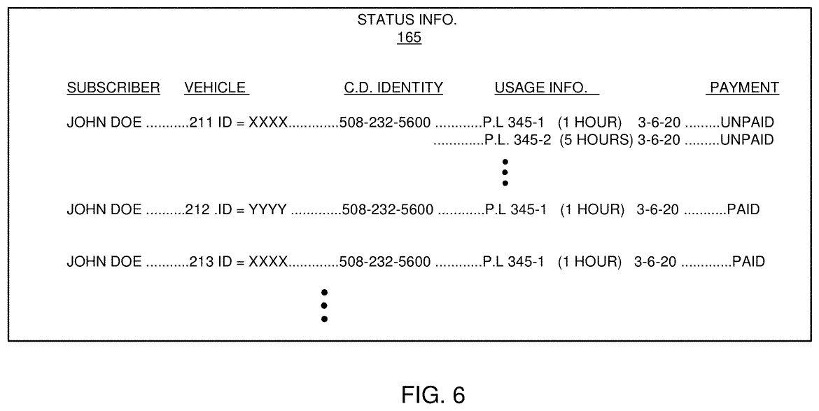

In accordance with yet further example embodiments, the registration of the vehicle 211 with the management resource 140 includes the mobile communication device 245 providing the management resource the unique identifier value XXXX assigned to the vehicle 211. Based on the received registration information, the management resource 140 produces status information 165 (see FIG. 6), mapping the unique identifier value XXXX, the vehicle 111, user 108, and the mobile communication device 245 to each other.

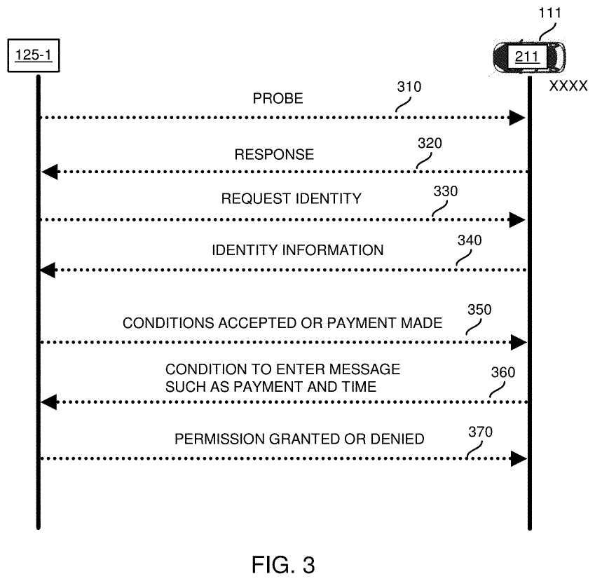

FIG. 3 is an example diagram illustrating a wireless communication protocol supporting communications between a wireless monitor station and a wireless station in a vehicle according to embodiments herein.

As previously discussed, the wireless station 125-1 and the wireless station 211 associated with vehicle 211 communicate over a respective wireless communication link 128-1.

In this example embodiment, the wireless station 125-1 repeatedly transmits a probe signal (such as at a low power level) in the monitored region 195 (such as once every 500 milliseconds or other suitable value) to any vehicles present in the monitored region 195. Repeated transmission of the probe signal communication 310 (such as a unique value assigned to the wireless station 125 and a unique value associated with the management resource 140) ensures that respective vehicles and corresponding wireless stations 211, 212, 213, etc., are made aware of the presence of the wireless station 125-1 in the monitored region 195.

In one embodiment, the probe signal (communication 310) indicates that entry into a respective area is controlled by an entity such as the management resource 140.

In accordance with further example embodiments, receipt of a unique application identifier value associated with the management resource 140 (such as application managing vehicles) notifies the wireless station 211 to execute a corresponding client traffic application in the wireless station 211 and/or the mobile communication device 245 operated by the respective user 108.

Thus, in one embodiment, the probe signal 310 includes information such as a unique application identity of the wireless station 125 and/or management resource 140. As the vehicle 111 enters the monitored region 195, the wireless station 211 decodes the probe signal 310.

In response to receiving the communication 310 (probe signal), the wireless station 211 instantiates a respective application on the wireless station 211 and transmits a wireless communication 320 (such as a probe response) to the wireless station 125. The probe response indicates presence of the vehicle 111 in the monitored region. The probe response potentially includes an identity (such as XXXX) of the vehicle 111.

In response to receiving the communication 320, assuming the wireless station 211 does not transmit the identity XXXX in the communication 320, the wireless station 125 communicates an identity request communication 330 to the wireless station 211.

In response to receiving the identity request communication 330 over wireless communication link 128-1, the wireless station 211 associated with the vehicle 111 communicates wireless communication 340 to the wireless station 125-1. The wireless communication 340 includes any suitable information such as a unique identifier value (such as value XXXX) to the wireless station 125. The unique identifier value can be any suitable information such as multi-bit digital value corresponding to one or more of: i) a respective license plate or vehicle identification number assigned to the vehicle 111, ii) an identity of the user 108 operating the vehicle 111, etc.

Additionally, the wireless station 125-1 forwards the identity or other information associated with the vehicle 111, user 108, etc., received from the wireless station 211 via one or more communications to the management resource 140. In one embodiment, the communications from the wireless station 125-1 to the management resource 140 include a request to perform a function such as enter a parking garage.

In accordance with further example embodiments, in response to receiving a respective communication indicating presence of the vehicle 111 in the monitored region 195, the management resource 140 determines how to control movement of the vehicle 111 in the monitored region 195.

In one embodiment, if the management resource 140 determines that the vehicle 111 and corresponding user 108 are allowed to enter a restricted region such as a parking lot, the management resource 140 notifies the wireless station 125-1 of such a condition. If the vehicle 111 corresponding user 108 are not allowed to enter the restricted area, the wireless station 125-1 denies entry of the vehicle 111 to the restricted area.

The reason for denial of entry into the restricted area can be conveyed/displayed to the viewer in any suitable manner. For example, the denial message can be displayed on: i) a respective display screen of the wireless station 125-1, ii) display screen of the wireless station 211, and/or iii) a respective display screen of the mobile communication device 245.

If desired, in response to detecting that the corresponding user 108 and vehicle 111 are allowed in a respective restricted area, the management resource 140 communicates conditions associated with entry of the vehicle 111 to the restricted area via the wireless communications 350 communicated from the wireless station 125-1 to the wireless station 211.

In one embodiment, in response to receiving the notification of conditions associated with entering the restricted area, a display screen (such as associated with the wireless station 211, wireless station 125, and/or mobile communication device 245) initiates display of the corresponding conditions (such as payment conditions) for viewing by the respective user 108 driving the vehicle 111.

Via wireless communications 360, the wireless station 211 (and/or mobile communication device 245 operated by user) accepts the conditions as specified by the wireless communications 350. Acceptance of the conditions can include making payment (such as to payment server 266 of FIG. 2) prior to entering or exiting a respective restricted area.

Via wireless communications 370, as indicated by the management resource 140, the wireless station 125-1 provides permission to the vehicle 111 to enter or exit a restricted area.

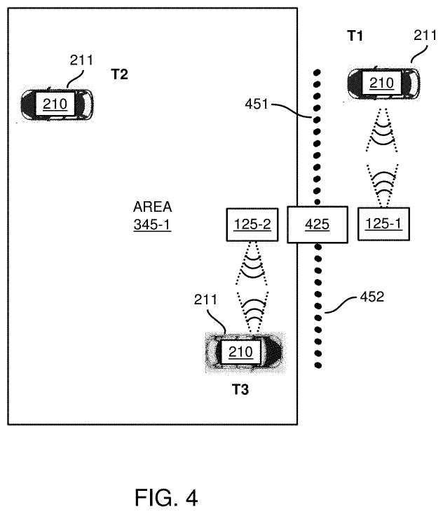

FIG. 4 is an example diagram illustrating management and tracking of a vehicle in a first parking lot according to embodiments herein.

In this example embodiment, the wireless station 211 associated with vehicle 111 wirelessly communicates with the management resource 140 through the wireless stations 125 (such as wireless station 125-1 and wireless station 125-2) in a manner as previously discussed (see wireless communication protocol in FIG. 3).

In one nonlimiting example embodiment, the wireless coverage for wireless signaling (such as V2I wireless communications over wireless communication link 128-1) from each of the wireless stations 125 is narrow beam such as a 2-30 degree (or any other suitable value) horizontal beam width to avoid activation of the system from a long distance above a threshold value. However, the wireless stations can transmit in all directions if desired. In one embodiment, wireless emissions from the wireless station 211 (such as emission from the wireless station 211) are larger to facilitate communication with the wireless station 125 and other wireless stations.

In accordance with yet further example embodiments, the wireless coverage transmitted from a respective wireless station 125-1 is limited to a region where vehicles enter the restricted area 345-1.

As further shown, at time T1, the wireless station 125-1 detects presence of the vehicle 111 attempting to enter the area 345-1 (such as via the wireless communication protocol as discussed in FIG. 3). For example, the wireless station 125-1 communicates a probe signal (310) and receives a probe response (320) from the wireless station 211. The wireless station 125-1 further receives a unique identifier value XXXX (such as in communications 340) assigned to the vehicle 211. network. The wireless station 125-1 communicates this information to management resource 140, which updates status information 165.

In response to detecting that the vehicle is permitted to enter the area 345-1 and that the user of vehicle 211 accepts terms (such as cost of parking or other suitable one or more terms) of entering into restricted area 345-1 (such as a parking garage), the management resource 140 causes the physical barrier 451 to raise via control communications to the wireless station 125-1, allowing the vehicle 111 to enter restricted area 345-1 at time T1.

Assume that between time T1 and time T3, the vehicle 111 is parked in the restricted area 345-1.

At time T3, after time T1 and T2, the vehicle 111 attempts to exit the restricted area 345-1. In a similar manner as previously discussed, the wireless station 125-2 detects presence of the wireless station 211 at the exit of the restricted area 345-1. For example, the wireless station 125-2 communicates a probe signal (310) and receives a probe response (320) from the wireless station 211. The wireless station 125-2 further receives a unique identifier value=XXXX assigned to the vehicle 211. The wireless station 125-2 communicates such information to the management resource 140 that tracks the vehicles.

Thus, while at the exit, the wireless station 125 establishes a respective wireless communication link with the wireless station 211. Based on communications from the wireless station to the management resource 140, the management resource 140 updates the status information 165 to reflect exiting of the respective vehicle 111 from the restricted area 345-1.

In one embodiment, in response to detecting that the vehicle 111 is attempting to exit the restricted area 345-1, the wireless station 125-2 initiates opening of the respective physical barrier 452. In such an instance, time T3, the vehicle 111 exits the restricted area 345-1. The management resource 140 updates the status information 165.

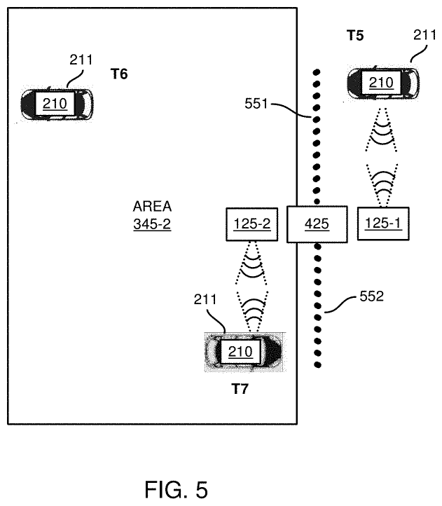

FIG. 5 is an example diagram illustrating management and tracking of a vehicle in a second area according to embodiments herein.

In this example embodiment, the wireless station 211 associated with vehicle 111 wirelessly communicates with the management resource 140 through the wireless station 125-2 in a manner as previously discussed (wireless communication protocol in FIG. 3).

In one nonlimiting example embodiment, the wireless coverage for wireless signaling (such as V2I wireless communications over wireless communication link 128-1) is narrow beam such as between 2-30 degree (or any other suitable value) horizontal beam width to avoid activation of the system from a large distance. Wireless emissions from the wireless station 211 (such as emission from the wireless station 211) are larger to facilitate communication with the wireless station 125-2 and other wireless stations.

In one embodiment, the wireless coverage transmitted from the wireless station 125-2 is limited to region where vehicles enter the restricted area 345-2.

As further shown, at time T5, the wireless station 125-2 detects presence of the vehicle 111 attempting to enter the area 345-2 (such as via the wireless communication protocol as discussed in FIG. 3). For example, the wireless station 125-2 communicates a probe signal (310) and receives a probe response (320) from the wireless station 211. The wireless station 125-2 further receives a unique identifier value XXXX (such as in communications 340) assigned to the vehicle 211.

In response to detecting that the vehicle is permitted to enter the area 345-2 and that the user of vehicle 211 accepts terms (such as cost of parking or other suitable one or more terms) of entering into restricted area 345-2 (such as a parking garage), the management resource 140 causes the physical barrier 551 to raise, allowing the vehicle 111 to enter restricted area 345-2 at time T5.

Assume that between time T5 and time T7, the vehicle 111 is parked in the restricted area 345-2.

At time T7, the vehicle 111 attempts to exit the restricted area 345-2. In a similar manner as previously discussed, the wireless station 125-4 detects presence of the wireless station 211 at the exit of the restricted area 345-2. For example, the wireless station 125-2 communicates a probe signal (310) and receives a probe response (320) from the wireless station 211. The wireless station 125-2 further receives a unique identifier value=XXXX assigned to the vehicle 211.

Thus, while at the exit, the wireless station 125-2 establishes a respective wireless communication link with the wireless station 211. Based on communications from the wireless station 125-2 to the management resource 140, the management resource 140 updates the status information 165 to reflect exiting of the respective vehicle 111 from the restricted area 345-2.

In one embodiment, in response to detecting that the vehicle 111 is attempting to exit the restricted area 345-2, and based on control input from the management resource 140, the wireless station 125-2 initiates opening of the respective physical barrier 552. In such an instance, at or around time T7, the vehicle 111 exits the restricted area 345-2.

FIG. 6 is an example diagram illustrating map information tracking vehicles and use of a respective parking lot according to embodiments herein.

As previously discussed, the monitor system (combination of wireless station 125 and management resource 140) as described herein receives registration of the first vehicle 111 via input from a mobile communication device 245 operated by a user of the first vehicle 111. In such an instance, the management resource 140 is aware of the vehicle 111 and corresponding unique identifier value (XXXX).

In this example embodiment, as previously discussed, status information 165 includes a log of the vehicle 111 and corresponding times of the vehicle 111 parking at different locations (such as area 345-1 and area 345-2).

The management resource 140 controls movement of the first vehicle 111 from the first region (such as entry area associated with barrier 451) based at least in part on the received identity of the vehicle (XXXX) as learned during registration by user 108. Based on detecting that the vehicle 111 was previously registered by the user 108, the management resource 140 and/or wireless station 125 notifies the user 108 of the vehicle 111 to pass to or exit the restricted area.

In one embodiment, management resource 140 determines fees due from the user 108 based on detected presence of the vehicle 111 in region 345-1 and region 345-2 at different times. Status information tracks, for each registered vehicle, whether fees are paid or unpaid.

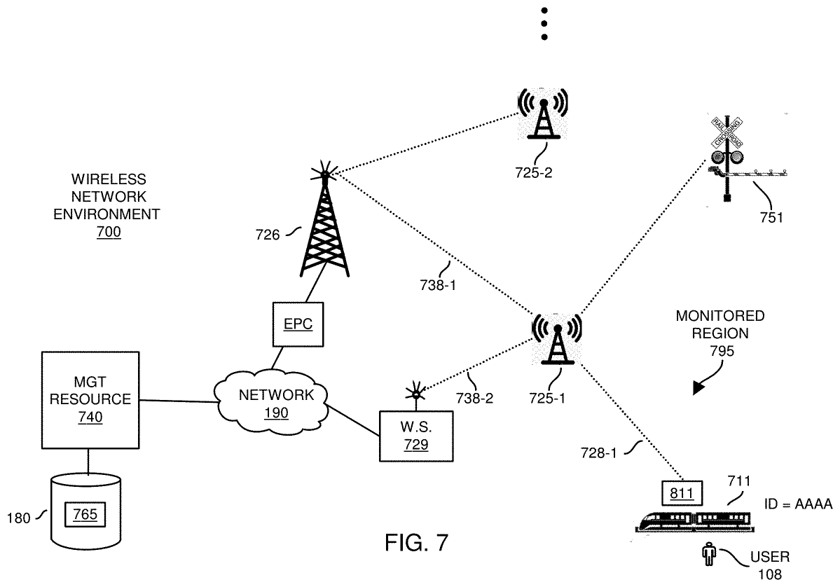

FIG. 7 is an example diagram illustrating a wireless network environment and vehicle management according to embodiments herein.

As shown, the wireless network environment 700 includes vehicle 711 and corresponding wireless station 811 in communication with wireless station 725-1. Note that the wireless network environment 100 includes any number of vehicles in communication with respective wireless stations 725-1.

Vehicle 711 (such as a train, subway vehicle, automobile, etc.) includes a corresponding wireless station 811 to communicate with the wireless station 725-1 (such as a road-side unit or RSU).

In one nonlimiting example embodiment, the wireless station 811 is affixed to the corresponding vehicle 711. In certain instances, the vehicle 711 includes multiple wireless stations such as a first wireless station disposed at a first end (such as headend) of the vehicle 711 and a second wireless station disposed at a second end (such as a tail end) of the vehicle 711.

As an alternative to being a wireless station 811 affixed to the vehicle 711, the wireless station 711 can be a handheld device operated by a respective driver operating (steering) vehicle 711.

In yet further example embodiments, the wireless station 811 is affixed to the vehicle 711; the respective driver of the vehicles operates a respective mobile communication device to receive one or more communications from the wireless station 725-1 regarding conditions associated with monitored wireless network environment 100.

As further shown, wireless communication link 728-1 supports wireless communications between the wireless station 725-1 and the wireless station 811. Via such communications, the management resource 740 monitors and potentially controls the vehicle 711, controls barrier 751, traffic lights, etc.

As further shown, wireless stations 725-1 is in communication with the management resource 740 via any of multiple different types of communication links. For example, in one embodiment, the wireless station 725-1 establishes a wireless communication link 738-1 between the wireless station 725-1 and the wireless station 726 (such as via LTE, 5G, etc.). Additionally or alternatively, the wireless station 725-1 establishes a respective wireless communication link 738-2 (such as based on WiFi™) with the wireless station 729.

Network 190 provides connectivity of the respective wireless station 726 and wireless station 729 to the management resource 140.

In one embodiment, as its name suggests, and as previously discussed, the management resource 140 manages one or more functions associated with vehicle, pedestrians, etc., associated with the wireless network environment 700.

In yet further example embodiments, the wireless station 811 on vehicle 711 communicates with the wireless station 725-1 (such as so-called road-side unit or RSU) at the entry into a corresponding area or geographical region. For example, the wireless station 725-1 monitors a respective railway for inbound and outbound vehicles on one or more rails.

In one embodiment, as further discussed herein, the wireless station 725-1 monitors both directions of a train track for vehicles such as trains, subways, etc.

Note that the wireless communication links 728-1, 738-1, 738-2, etc., can support any type of wireless communications. For example, in one embodiment, the wireless communication link 728-1 supports wireless connectivity between the wireless station 725-1 and the wireless station 811 in accordance with a V2I (Vehicle to Infrastructure) wireless communication protocol. Additionally, or alternatively, the wireless communication links support LTE, WiFi™, 5G, or any suitable type of wireless communication.

Via respective wireless communications between the wireless station 811 and the management resource 140 (including the wireless communication link 728-1 and communication link 738, through network 190, etc.), the management resource 140 performs one or more functions associated with the vehicle 811. For example, the management resource 140: i) tracks a location of the vehicle, ii) controls physical barrier 751 associated with vehicle 711, iii) notifies pedestrians of the presence of the vehicle 711 in the monitored region, etc.

Note that wireless network environment 700 can be configured to include any number of wireless monitor stations 725 such as a first wireless monitor station 725-1, a second wireless monitor station 725-2, etc.

The wireless station 725-1 monitors a first region in which one or more vehicles frequent such as automobiles, trains, etc. The wireless station 725-2 monitors a second region (such as railway) in which one or more vehicles frequent such as automobiles, trains, etc.

During operation, assume that the first wireless station 725-1 receives a wireless communication from the wireless station 811 indicating presence of a vehicle 711 in the first monitored region (such as a railway on which vehicle travels). The first communication includes a unique identifier value (such as unique identifier value of AAAA) assigned to the vehicle 711.

Based on detected presence of the vehicle 711 in the monitored region as indicated by the wireless communications and corresponding first unique identifier value AAAA, and based on control input from the management resource 140 or other suitable entity, the wireless station 725-1 controls traffic flow (of one or more other vehicles) associated with the monitored wireless network environment 700 (one or more regions, sub-regions, etc.) via control of barrier 751.

As further discussed herein, traffic flow control can include: i) communicating control information to the wireless station 811 that, in turn, controls respective vehicle 711, ii) controlling (such as opening and closing) a physical barrier such as a gate, etc.

In one embodiment, each of the wireless stations 725 are connected wirelessly back to the backbone network 190 through a wireless communication links 738-1, 738-2, etc.

In accordance with further example embodiments:
Command and control via management resource can also over-ride manual control of the barriers.
The wireless stations and the vehicles communicate in accordance with a V2I protocol. In one embodiment, the communications between the wireless station 725-1 and the wireless station 811 occur over a secured (encrypted) communication channel.
Vehicles will have unique identities that are sent over the respective wireless communication link to the wireless station 725-1. If the unique identity is identified correctly by the wireless station 725-1, it will control operation of the barrier 751.
A remote cloud will host the application (management resource 740) as well repository 780.

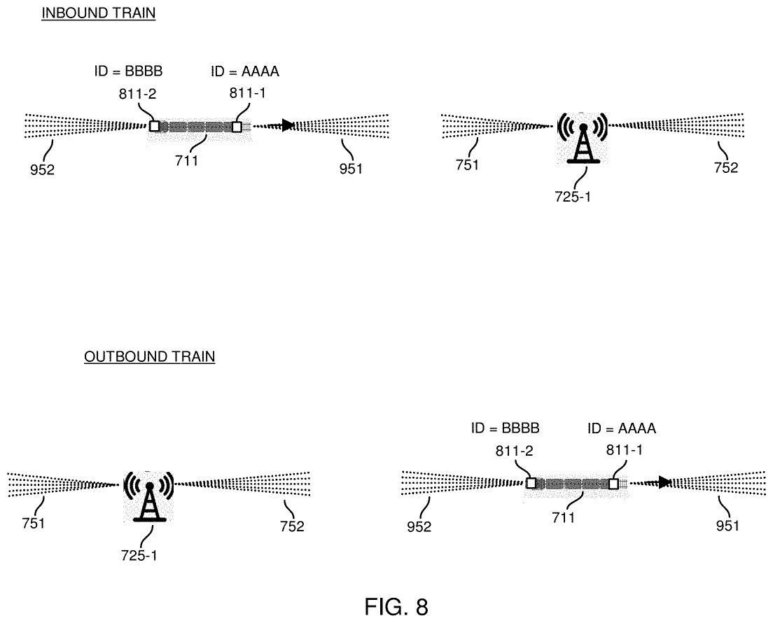

FIG. 8 is an example diagram illustrating detection of an inbound and outbound vehicle according to embodiments herein.

In one embodiment, the wireless station 725-1 sends an always on signal or a wireless notification signal that is sent only when a vehicle such as train is anticipated within a window of 1-5 minutes. This can be set in the command and control system (management resource 140 associated with the wireless station 725-1) depending on the schedule of the train and its anticipated arrival at a respective intersection.

However, delays can impact the anticipated arrival of a vehicle at a particular location. In such an instance, the system can be adjusted as per location of the train.

In yet further example embodiments, the vehicle includes multiple communication devices that are potentially in communication with the wireless station 725-1 at different times. For example, the vehicle 711 may be a train including multiple train cars. A first communication device 811-1 assigned a first unique identifier value AAAA is affixed to a leading end of the vehicle 711. As shown, the wireless station 725-1 detects the leading end of the vehicle 711 first because of the narrow wireless beam 951 communicated from the wireless station 811-1 to the wireless station 725-1. The wireless station 725-1 monitors the upstream direction of a respective railway via wireless pattern 751. Wireless station 725-1 monitors the downstream direction of the railway via wireless pattern 752 and does not detect any vehicles.

Eventually the wireless station 811-1 of the vehicle 711 passes the wireless station 725-1. In such an instance, the wireless station 725-1 is not communication with any of the wireless stations 811 associated with the vehicle 711 because of the directional wireless beams transmitted from each respective wireless station.

Note that the wireless station 811-2 (second communication device) is assigned a second unique identifier value and is affixed to a trailing end and of the vehicle 711. Eventually, the vehicle 711 and corresponding wireless station 811-2 travel sufficiently down the railway (to the right) such that the wireless station 725-1 now detects the wireless station 811-2 (bottom of FIG. 8).

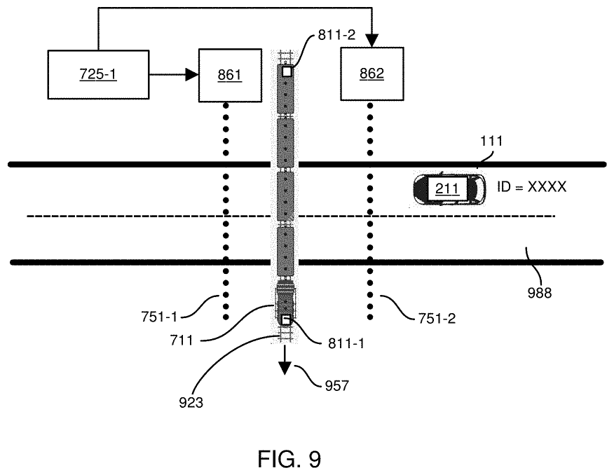

More specifically, wireless station 725-1 communicates in the downstream direction via wireless pattern 752 (such as narrow wireless beam transmitted downstream on the railway). The wireless station 811-2 communicates (unique identifier value=BBBB) in the upstream direction via wireless beam 952 to the wireless station 725-1. Detection of the unique identifier value BBBB indicates that the respective vehicle 711 has passed the corresponding wireless station 725-1. In such an instance, the wireless station 725-1 raises the respective one or more barriers 751. Accordingly, the different directional beams associated with the vehicle 711 indicate location and direction that are then used to control a physical barrier, allowing passage across a vehicle intersection. An example of controlling one or more barriers is further discussed in FIG. 9

FIG. 9 is an example diagram illustrating control of traffic at an intersection according to embodiments herein.

In this example embodiment, the vehicle 711 travels in the southbound direction 957 on a respective railway 923.

As previously discussed, the wireless station 725-1 detects presence of the wireless station 725-1. The detected presence of the vehicle 711 causes the management resource 742 to lower both barrier 751-1 and 751-2 as the corresponding vehicle crosses over the roadway 988. Lowering of the barrier 751-2 prevents the vehicle 111 from being in a path of the vehicle 711 as it passes along the railway 923.

Thus, the vehicle 711 as described herein travels on a first vehicle pathway (such as railway 923) through the monitored region. The control input from the management resource 740, which verifies the identity (AAAA) of the vehicle 711, causes the wireless station 725-1 to control the physical barriers 751 at the intersection of the first vehicle pathway (railway 923) crossing the second vehicle (pathway roadway 988). The physical barriers control movement of the vehicle 111 along the second vehicle pathway 988 based on the detected presence of the first vehicle in the monitored region.

In one embodiment, via input from the respective management resource 740 to the controllers 861 and 862, the wireless station 725-1 controls movement of the respective vehicle 711. In one embodiment, the wireless station 711 also communicates one or more control or notification signals to the vehicle 711, granting permission to the vehicle 711 to pass through the intersection.

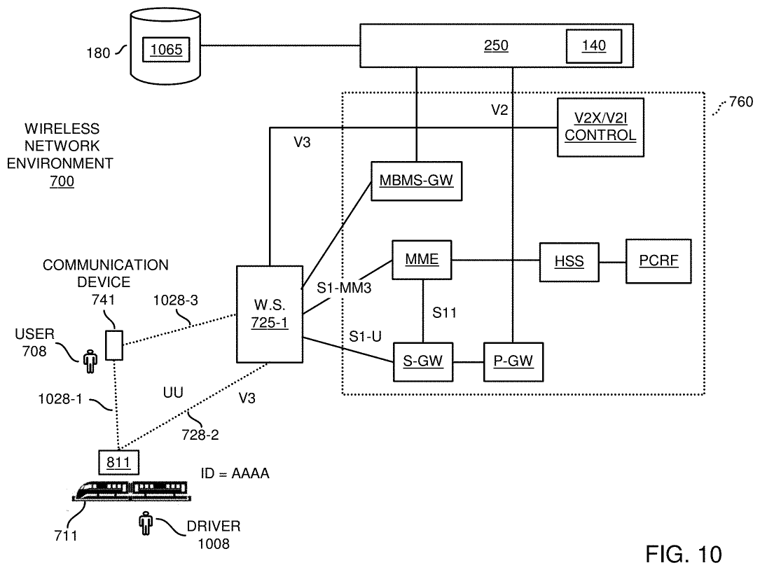

FIG. 10 is an example diagram illustrating a wireless system and corresponding management of vehicles according to embodiments herein.

In this example embodiment, the wireless network environment 700 includes wireless network core 760 including MBMS-GW, MME, S-GW, P-GW, HSS, V2X/V2I Controller, PCRF, etc.

The core 760 provides connectivity between the respective one or more wireless stations 725-1 and the management resource 740 (traffic management resource).

In this example embodiment, the wireless communication link 728-2 supports communications via one or more wireless communication protocols over one or more corresponding wireless communication bands to the wireless station 725-1.

Communication device 741 operated by the user 708 (such as a pedestrian) is in communication with the management resource 740 over wireless communication link 1028-3 through wireless station 725-1 and network 190. The mobile communication device 741 receives wireless communications from wireless station 811 and/or wireless station 725-1.

Note that, in one embodiment, the management resource 740 (such as hardware and/or executed software) is a V2I application executed on application server 250.

In a similar manner as previously discussed, management resource 140 has access to repository 180 (such as in the cloud or other suitable location), which stores status information 1065 (a.k.a., management information, mapping information, etc.). In one embodiment, the status information 1065 stores any suitable information such as vehicle information including unique identifier value assigned to each of the respective vehicles being monitored.

As further discussed herein, the status information 1065 such as derived at least in part on the owner of the vehicle 711 registering with the management resource 140. In one embodiment, the management resource 740 has a schedule indicating when a respective vehicle on the railway 923 is expected to arrive or be present.

In accordance with yet further example embodiments, the registration of the vehicle 711 with the management resource 140 includes the respective vehicle owner/operator providing the management resource 741 with the unique identifier values AAAA and BBBB associated with the wireless station 811-1 and 811-2.

In one embodiment, the wireless station 725-1 repeatedly transmits probe requests in the monitored region to learn of presence/arrival of a respective vehicle, regardless of whether the vehicle is expected to be presence or not. If a respective vehicle is expected to arrive at the scheduled time (or in a window of time), the wireless station 725-1 can be configured to increase a rate at which wireless probe requests are transmitted in the monitored region (upstream along the railway 923) to ensure that the vehicle 811 is detected as being present as early as possible.

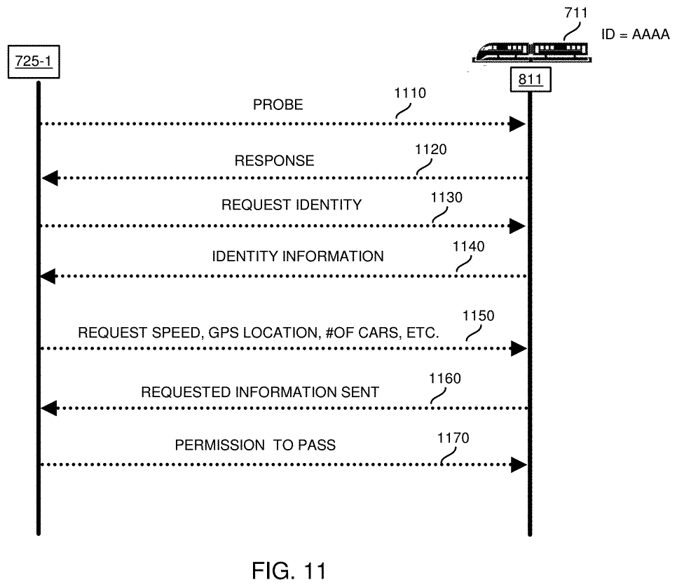

FIG. 11 is an example diagram illustrating a wireless communication protocol supporting communications between a wireless monitor station and a vehicle according to embodiments herein.

As previously discussed, the wireless station 725-1 and the wireless station 811-1 associated with vehicle 711 communicate over a respective wireless communication link 728-1.

In this example embodiment, the wireless station 725-1 repeatedly transmits a probe signal (such as at a low power level) in the monitored region (such as once every 500 milliseconds) to any vehicles present on railway 923 in the upstream or downstream direction. Repeated transmission of the probe signal communication 1110 (such as a unique value assigned to the wireless station 725-1 and a unique value associated with the management resource 140) ensures that respective vehicle 711 and corresponding wireless stations 811-1 and 811-2 are made aware of the presence of the wireless station 725-1 in the monitored region.

In one embodiment, the probe signal (such as communication 1110) indicates that entry into a respective area is controlled or monitored by an entity such as the management resource 740.

In accordance with further example embodiments, receipt of a unique application identifier value associated with the management resource 740 (such as application managing vehicles) notifies the wireless station 811 to execute a corresponding client traffic application in the wireless station 811 and/or the mobile communication device 741 operated by the respective user 708.

Thus, in one embodiment, the probe signal 1110 includes information such as a unique application identity of the wireless station 725-1 and/or management resource 740. As the vehicle 711 enters the monitored region (such as railway 923), the wireless station 811 decodes the probe signal 1110.

In response to receiving the communication 1110 (probe signal), the wireless station 811 instantiates a respective application on the wireless station 811 and transmits a wireless communication 1120 (such as a probe response) to the wireless station 725-1. The probe response (communication 1120) indicates presence of the vehicle 711 in the monitored region. The probe response potentially includes an identity (such as AAAA) assigned to the wireless station 811 of the vehicle 711.

In response to receiving the communication 1120, assuming the wireless station 811 does not transmit the identity AAAA in the communication 1120, the wireless station 725-1 communicates an identity request communication 1130 to the wireless station 811.

In response to receiving the identity request communication 1130 over wireless communication link 728-1, the wireless station 811 associated with the vehicle 811 communicates wireless communication 1140 to the wireless station 725-1. The wireless communication 1140 includes any suitable information such as a unique identifier value (such as value AAAA) to the wireless station 725-1. The unique identifier value can be any suitable information such as multi-bit digital value corresponding to one or more of: i) a respective vehicle identification number assigned to the vehicle 711, ii) an identity of the user operating the vehicle 711, etc.

The wireless station 725-1 forwards the identity or other received information associated with the vehicle 711 to the management resource 740.

This further shown, in response to receiving the identity information associated with the wireless station 811 in communication 1140, the wireless station 725-1 communicates a respective inquiry via communications 150 to the wireless station 811. In one embodiment, the communications 1150 specify different types of information (such as speed of the vehicle 711, specific location of the vehicle 711, length of the vehicle 711, # of cars associated with the vehicle 711, etc.) associated with the vehicle 711 to be communicated to the wireless station 725-1.

In response to receiving communication 1150, in corresponding inquiry, the wireless station 811 communicates the requested information via communications 1160 to the wireless station 725-1.

As previously discussed, the management resource 740 controls passage of the vehicle 711 through a respective intersection. In one embodiment, via communications 1170, the wireless station 725-1 notifies the vehicle 711 that it has permission to travel through the respective intersection.

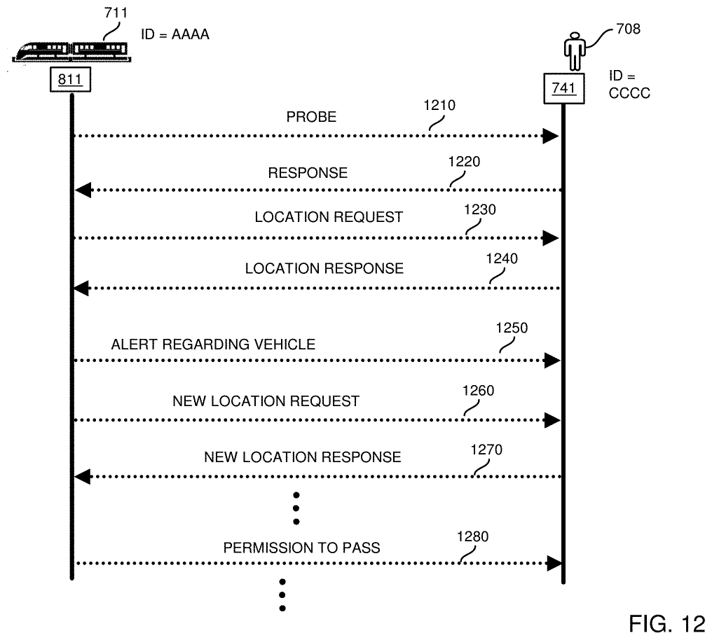

FIG. 12 is an example diagram illustrating a wireless communication protocol supporting communications between a wireless monitor station and a pedestrian according to embodiments herein.

In one embodiment, the wireless station 811 communicates a probe communication 1210 via wireless pattern 951 (FIG. 8) to determine presence of any pedestrians in a pathway 957 (FIG. 9) of the respective vehicle 711.

Assume in this example embodiment, that the communication device 741 receives the probe communication 1210. In response to receiving the probe communication 1210, the communication device 741 transmits response communications 1220 to the wireless station 811. In such an instance, the wireless station 811 is made aware of a presence of the corresponding user 708 disposed in a pathway 957 of the vehicle 711.

In accordance with further embodiments, in response to receiving the response communication 1220, the wireless station 811 transmits a location request communication 1230 to the communication device 741. As its name suggests, the location request communication 1230 requests the communication device 741 to provide its current location to the wireless station 811.

The communication device 741 responds with a location response communication 1240 to the wireless station 811. In one embodiment, the location response communication 1240 indicates the precise location of the corresponding mobile communication device 741 and corresponding user 708.

The wireless station 811 (and corresponding management resource 740) determines from the received location response communication 1240 that the user 708 is in a pathway of the corresponding vehicle 711. In response to the detected condition, the wireless station 811 generates a respective alert communication 1250 to the mobile communication device 741. The alert communication 1240 notifies the user 708 that the vehicle 711 is traveling toward the user 708 and that the user 708 is potentially in danger.

In accordance with further example embodiments, as that the vehicle 711 approaches the location where the user 708 is located as indicated by the prior location response communication 1240, the wireless station 811 transmits a second location request communication 1260 to the communication device 741 and corresponding user 708. In response to receiving such a communication 1260, the communication device 741 operated by the user 708 transmits a second location response communication 1270 to the wireless station 811. The location response communication 1170 indicates the current location of the user 708 and corresponding communication device 741.

The wireless station 811 repeats the process of monitoring the location of the corresponding user 708 to determine if it is safe to continue traveling along the railway 923 past the corresponding user 708. In one embodiment, in response to detecting that the user 708 is no longer in the pathway of the vehicle 711 as indicated by the location response communication 1270, the corresponding driver of the vehicle 711 travels past the out of the way user 708. Conversely, if the wireless station 811 receives feedback from the corresponding communication device 741 that the user 708 is still in the pathway of the vehicle 711, the wireless station 811 and/or corresponding driver stops the vehicle, preventing the user 708 from being injured.

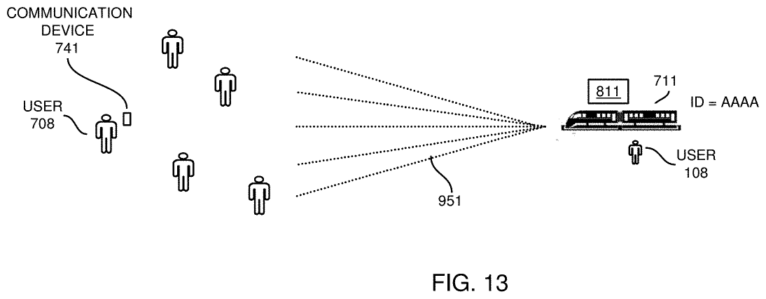

FIG. 13 is an example diagram illustrating monitoring of pedestrians in a wireless network according to embodiments herein.

As previously discussed, the vehicle 711 is equipped with the wireless station 811. Wireless station transmits the wireless radiation pattern 951 to detect presence of one or more pedestrians. In one embodiment, via the protocol as previously discussed in FIG. 12, the wireless station 811 detects presence of the user 708 and corresponding communication device 741 in the pathway of the vehicle 711.

Referring again to FIG. 10, note again that the wireless monitor station 725-1 can be configured to monitor presence of any type of entity in the monitored region. For example, in one embodiment, the wireless monitor station 725-1 detects presence of a pedestrian (user 708) in the monitored region as well as the vehicle 711. In such an instance, the wireless station 725-1 notifies an operator of the vehicle 711 of the presence of the pedestrian (user 708) in the monitored region.

In one embodiment, the wireless station 725-1 detects that the pedestrian is located in a corresponding path (railway 923) of the vehicle 711 and that the pedestrian is in danger of being run over. In this case, the notification (alert message) from the wireless station 725-1 to the communication device 741 ensures that the pedestrian is aware of the incoming vehicle 711. Additionally, or alternatively, the wireless station 725-1 communicates a notification (alert message) from to a communication device operated by the driver 1008 (or wireless station 811-1), ensuring that the driver is aware of the specific geographical location of the pedestrian in danger.

Thus, the wireless station 725-1 can be configured to provide notification of the detected presence of the vehicle 711 in the monitored region to a communication device operated by a user disposed in a pathway of the vehicle 711. In such an instance, the user is notified of potential danger of the corresponding vehicle 711. If the wireless station 725-1 or wireless station 811 detects that the user (such as a pedestrian) is still present in a pathway of the corresponding vehicle after providing notification of same, the wireless station 811 or other suitable resource can be configured to control operation (such as stopping) of the vehicle 711 such that the user is not injured.

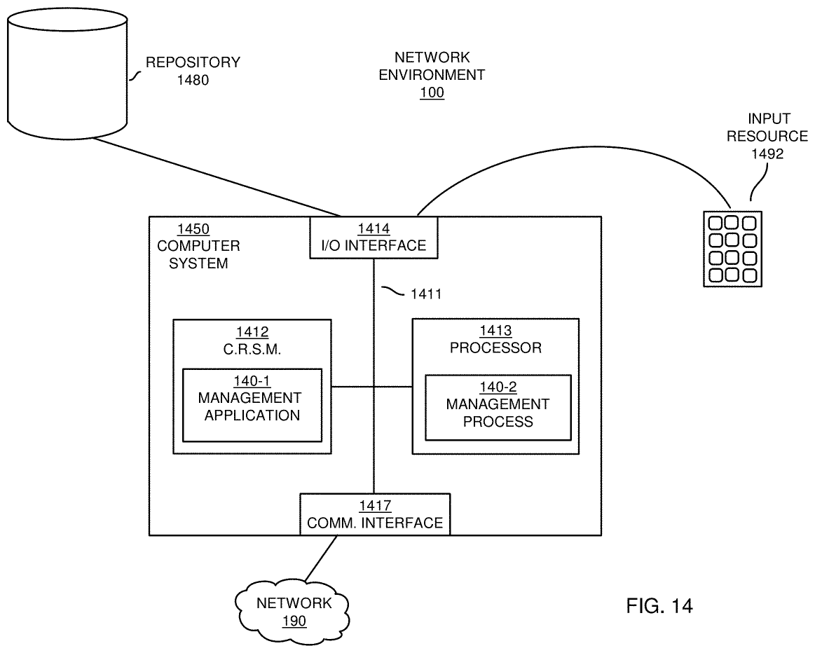

FIG. 14 is an example block diagram of a computer system for implementing any of the operations as discussed herein according to embodiments herein.

Any of the resources (e.g., playback device, wireless access point, controller resource, management resource, call router, call handler station, etc.) can be configured to include a processor and executable instructions to carry out the different operations as discussed herein.

As shown, computer system 1450 of the present example can include an interconnect 1411 that couples computer readable storage media 1412 such as a non-transitory type of media (i.e., any type of hardware storage medium) in which digital information can be stored and retrieved, a processor 1413 (computer processor hardware), I/O interface 1414, and a playbacks interface 1418.

Computer readable storage medium 1412 can be any hardware storage device such as memory, optical storage, hard drive, floppy disk, etc. In one embodiment, the computer readable storage medium 1412 stores instructions and/or data.

As shown, computer readable storage media 1412 can be encoded with content management application 140-1 (e.g., including instructions) to carry out any of the operations as discussed herein.

During operation of one embodiment, processor 1413 accesses computer readable storage media 1412 via the use of interconnect 1411 in order to launch, run, execute, interpret or otherwise perform the instructions in content management application 140-1 stored on computer readable storage medium 1412. Execution of the content management application 140-1 produces content management process 140-2 to carry out any of the operations and/or processes as discussed herein.

Those skilled in the art will understand that the computer system 1450 can include other processes and/or software and hardware components, such as an operating system that controls allocation and use of hardware resources to content management application 140-1.

In accordance with different embodiments, note that computer system may be or included in any of various types of devices, including, but not limited to, a mobile computer, a personal computer system, a wireless device, base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc.

The computer system 1450 may reside at any location or can be included in any suitable resource in any network environment to implement functionality as discussed herein.

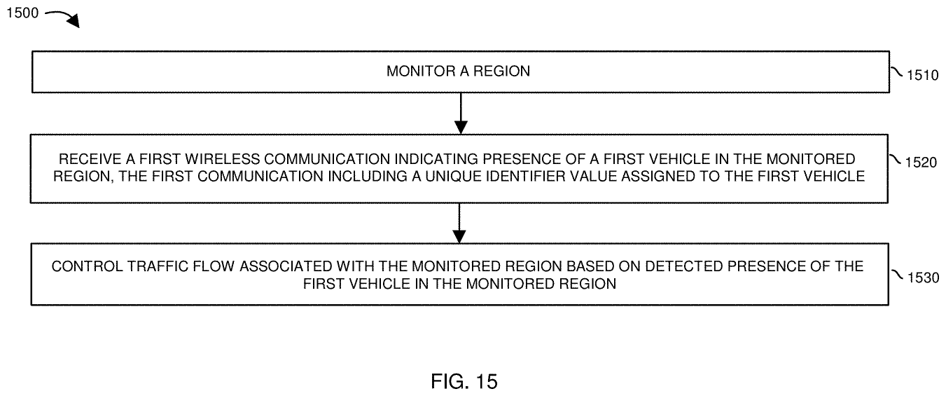

Functionality supported by the different resources will now be discussed via flowcharts in FIG. 15. Note that the steps in the flowcharts below can be executed in any suitable order.

FIG. 15 is a flowchart 1500 illustrating an example method according to embodiments. Note that there will be some overlap with respect to concepts as discussed above.

In processing operation 1510, the wireless station 125 monitors a region for presence of a vehicle.

In processing operation 1510, the wireless station 125 receives a first wireless communication indicating presence of a first vehicle in the monitored region, the first communication including a unique identifier value assigned to the first vehicle.

In processing operation 1510, the wireless station 125 control traffic flow associated with the monitored region based on detected presence of the first vehicle in the monitored region.

Note again that techniques herein are well suited to facilitate monitoring of vehicles and controlling traffic. However, it should be noted that embodiments herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

1. A method comprising:
via first wireless monitor station:
monitoring a region;
receiving a first wireless communication indicating presence of a first vehicle in the monitored region, the first communication including a unique identifier value assigned to the first vehicle; and
controlling traffic flow associated with the monitored region based on detected presence of the first vehicle in the monitored region.

2. The method as in claim 1 further comprising:
receiving the first wireless communication in response to communicating a probe request from the first wireless station in the monitored region

3. The method as in claim 1, wherein the first wireless communication is encoded in accordance with a V2I (Vehicle-to-Infrastructure) communication protocol.

4. The method as in claim 1, wherein a remote wireless station producing the first wireless communication is affixed to the first vehicle.

5. The method as in claim 1, wherein controlling traffic flow includes controlling movement of a physical barrier, allowing the first vehicle to pass.

6. The method as in claim 1 further comprising:
via the first wireless monitor station, monitoring presence of the first vehicle in a first authorized area.

7. The method as in claim 5 further comprising:
communicating a second probe request, the second probe request communicated from a second wireless monitor station to detect vehicular presence in a second region, the second wireless monitor station disposed at a disparate location with respect to the first wireless monitor station;
receiving a second wireless response at the second wireless station, the second wireless response indicating presence of the first vehicle in the second region, the second wireless response including the unique identifier value assigned to the vehicle; and
controlling movement of the first vehicle from the second region based at least in part on the second wireless response.

8. The method as in claim 1 further comprising:
prior to controlling movement of the first vehicle, providing notification of a fee due to a user of the vehicle; and
in response to detecting payment of the fee due, notifying a user of the vehicle to pass through the first region.

9. The method as in claim 1 further comprising:
receiving registration of the first vehicle via input from a mobile communication device operated by a user of the first vehicle; and
controlling movement of the first vehicle from the first region based at least in part on the first wireless communication; and
notifying the user of the vehicle to pass through the first region in response to detecting the registration.

10. The method as in claim 9, wherein the registration includes the mobile communication device providing the unique identifier value assigned to the first vehicle; and
wherein the unique identifier value provides a mapping of the vehicle to the mobile communication device.

11. The method as in claim 1 further comprising:
receiving the first wireless communication in response to communicating a probe request from the first wireless monitor station, the probe request transmitted in a window of time in which the first vehicle is scheduled to be present in the monitored region

12. The method as in claim 1 further comprising:
verifying an identity of the first vehicle based on the unique identifier value.

13. The method as in claim 1 further comprising:
receiving the first wireless communication from a first communication device disposed at a leading end of the vehicle passing through the monitored region.

14. The method as in claim 13 further comprising:
receiving a second wireless communication, the second wireless communication received from a second communication device disposed at a trailing edge of the first vehicle passing through the monitored region.

15. The method as in claim 1, wherein the first vehicle travels on a first vehicle pathway through the monitored region, the method further comprising:
controlling a physical barrier at an intersection of a second vehicle pathway crossing the first vehicle pathway, the physical barrier controlling movement of a second vehicle along the second vehicle pathway based on the detected presence of the first vehicle in the monitored region.

16. The method as in claim 15 further comprising:
communicating a signal to the first vehicle, the signal including permission granted to the first vehicle to pass through the intersection

17. The method as in claim 1 further comprising:
receiving a second wireless communication indicating a length and speed of the first vehicle.

18. The method as in claim 1 further comprising:
via the first wireless monitor station:
detecting presence of a pedestrian in the monitored region; and
notifying an operator of the first vehicle of the presence of the pedestrian in the monitored region.

19. The method as in claim 1 further comprising:
providing notification of the detected presence of the first vehicle in the monitored region to a communication device operated by a user disposed in a pathway of the first vehicle.

20. The method as in claim 11 further comprising:
controlling operation of the first vehicle in response to detecting that the communication device operated by the user continues to reside in a pathway of the first vehicle after providing the notification.

21. A system comprising:
a first monitor station operative to:
wirelessly communicate a first probe request to detect vehicular presence in a first region of interest;
receive a first wireless response indicating presence of a vehicle in the first region of interest, the first response including a unique identifier value assigned to the vehicle; and
control movement of the vehicle from the first region of interest based at least in part on the first wireless response.

22. The system as in claim 21, wherein the first monitor station is further operative to:
wirelessly communicate the probe request and receiving the first wireless response in accordance with a V2I (Vehicle-to-Infrastructure) communication protocol.

23. The system as in claim 21, wherein a wireless communication device producing the wireless response is affixed to the vehicle.

24. The system as in claim 21, wherein the first monitor station is further operative to:
control movement of a physical barrier, allowing the vehicle to pass.

25. The system as in claim 21 wherein the first monitor station is further operative to:
monitor presence of the vehicle in a first authorized area.

26. The system as in claim 25, wherein the first monitor station is further operative to:
communicate a second probe request, the second probe request communicated from a second monitor station to detect vehicular presence in a second region of interest, the second monitor station disposed at a disparate location with respect to the first monitor station;
receive a second wireless response at the second monitor station, the second wireless response indicating presence of the vehicle in the second region of interest, the second response including the unique identifier value assigned to the vehicle; and
control movement of the vehicle from the second region of interest based at least in part on the second wireless response.

27. The system as in claim 26, wherein the second monitor station is further operative to: monitor presence of the vehicle in a second authorized area, the system further comprising:
an invoicing engine operative to calculate fees due from a user based on monitored presence of the vehicle in the first authorized area and the second authorized area.

28. The system as in claim 21, wherein the second monitor station is further operative to:
prior to controlling the movement, providing notification of a fee due to a user of the vehicle; and
in response to detecting payment of the fee due, notifying the user of the vehicle to pass through the first region of interest.

29. Computer-readable storage hardware having instructions stored thereon, the instructions, when carried out by computer processor hardware, cause the computer processor hardware to:
wirelessly communicate a first probe request to detect vehicular presence in a first monitored region;
receive a first wireless response indicating presence of a vehicle in the first monitored region, the response including a unique identifier value assigned to the vehicle; and
control movement of the vehicle from the first region of interest based at least in part on the first wireless response.

30. The method as in claim 6 further comprising:
via the second wireless station, monitoring presence of the first vehicle in a second authorized area; and
calculating fees due from a user based on monitored presence of the first vehicle in the first authorized area and the second authorized area.
